(19) United States
(12) Patent Application Publication
(10) Pub. No.: US 2009/0248583 A1
(43) Pub. Date: Oct. 1, 2009

(54) DEVICE, SYSTEM, AND METHOD FOR SECURE ONLINE TRANSACTIONS

(76) Inventor: Jasmeet CHHABRA, Hillsboro, OR (US)

Correspondence Address: PEARL COHEN ZEDEK LATZER, LLP, 1500 BROADWAY, 12TH FLOOR, NEW YORK, NY, 10036, US

(21) Appl. No.: 12/058,950

(22) Filed: Mar. 31, 2008

(51) Int. Cl. H04L 9/32; G06Q 20/00

(52) U.S. Cl. 705/76

(57) ABSTRACT

A device, system, and method for providing an Internet webpage using a primary operating system for conducting an online transaction and for providing an interface associated with the Internet webpage using a secondary operating system. The data entered by a user into the interface may be inaccessible to the primary operating system. The secondary operating system may verify the data entered by the user, for example, by comparing the entered data with secret data. The secret data may correspond to an account. The secret data may be stored in a hardware location of a computing device. When the data entered by the user is verified, a request may be transmitted to a server associated with the account. In response to the transmitting, a transaction specific code may be received for completing the online transaction. Other embodiments are described and claimed.

### BACKGROUND OF THE INVENTION

Online electronic transactions are being used at an exponentially increasing rate. Security measures have been developed to protect such transaction from misuse, such as an unauthorized transfer of money by system hackers.

One such security measure uses transaction specific credit card numbers. A transaction specific credit card number may be used instead of a permanent or real credit card number, accessing the same account as a related permanent credit card number, but only for executing a user-specified transaction.

Typically, a user requests the transaction specific credit card number for completing a specific transaction. In response to the user request, a bank server may require the user to enter secret data, such as, the user's real credit card information, a secret PIN (personal identification) number or code, or other information to verify the user's identity. Once the secret data is verified, the bank server provides the user with the transaction specific credit card number for completing the transaction.

Since the transaction specific credit card number may only be used for a specific transaction, this number is not easily misused. However, the secret data provided by the user to acquire this number may not be secure. For example, in one case, the user may enter secret data into a user interface of a web-browser provided by an operating system (OS) of a computer. An unauthorized party may access the OS or other data on the computer and misuse that secret data.

A need exists for preventing unauthorized access to secret data used for executing a transaction.

### BRIEF DESCRIPTION OF THE DRAWINGS

Various embodiments of the present invention are illustrated in the following drawings, which are meant to be exemplary only and are not limiting on the scope of the present invention, and in which:

FIG. 1 is a schematic illustration of a system according to an embodiment of the invention;

FIG. 2 is a schematic illustration of a user display including a webpage for provide transaction offer information and an embedded screen for accepting user data according to an embodiment of the invention; and

FIG. 3 is a flowchart of a method in accordance with an embodiment of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DESCRIPTION OF THE PREFERRED EMBODIMENT

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

As used herein, the term “component” may refer to programming logic and associated data that may be employed to obtain a desired outcome. The term component may be synonymous with “module” or “agent” and may refer to programming logic that may be embodied in hardware or firmware, or in a collection of software instructions, possibly having entry and exit points, written in a programming language, such as for example C++, Intel Architecture 64 bit (IA-64) executable code, etc. Further, components may be callable from other components or from themselves, and/or may be invoked in response to detected events or interrupts. For example, a component may be a software package, module or agent executed by one or more processors.

Embodiments of the invention may include a manageability engine to retrieve a randomized, one time use, transaction specific, and/or secure credit card number, or other transaction number, for securely executing a transaction therewith. The manageability engine may send the secure credit card number to an embedded module (e.g., a browser plug-in), which in turn may enter the number into a credit card field or other transaction field of a webpage as if the user had directly entered it on the keyboard. The manageability engine may be localized in a hardware portion of a computer so that any secret data entered into the embedded module may not be read by the OS, which may not be sufficiently secure, according to some standards. Alternately the manageability engine or its functionality may be embodied in protected or secure software executed by for example a main processor and/or OS of a computer, or its functionality may be embodied in a manner other than a separate module.

Secret data may include, for example, real credit card information, a secret PIN number, a password, a voice sample, a retina scan, or other information to verify an account holder's identity and/or intention to execute a specific transaction. Secret data may refer to the data stored securely in a vault or hardware memory location and to data entered by a user into an embedded or other module used for releasing the stored data. In other embodiments, the secret data does not include a credit card number, account number, etc. and may include other data such as a request signal, a code, name, flag, Internet connection, encrypted data, etc. corresponding to or associated with a user, a computer, or an account. Secret data may refer to any data which may be used to gain access to an account provided by a bank or other server. Secret data may be any code for completing a transaction.

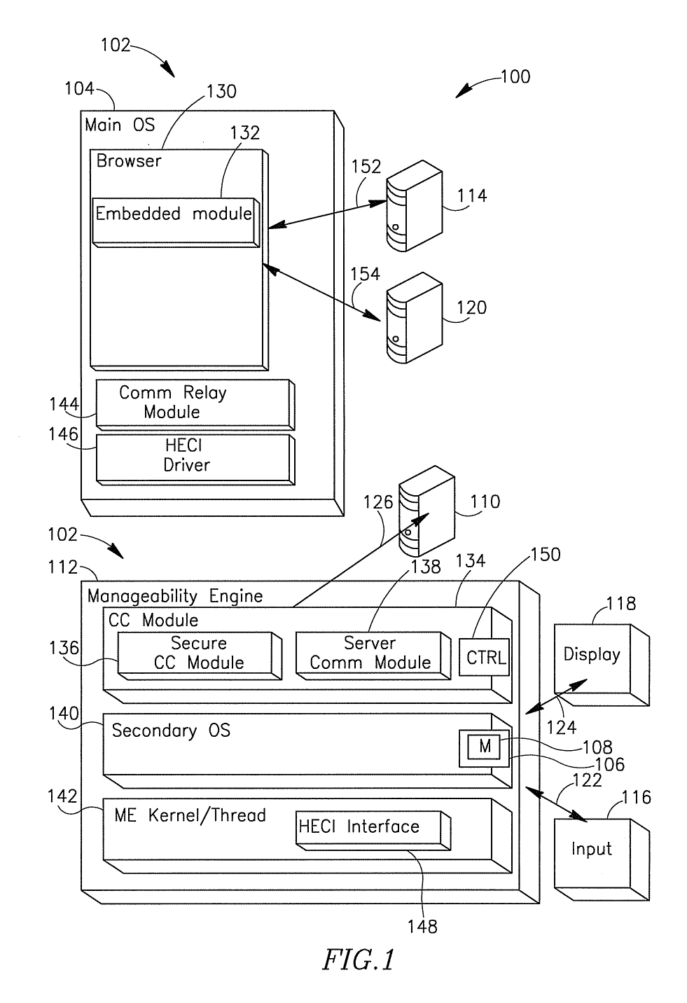

Reference is made to FIG. 1, which schematically illustrates a system 100 according to an embodiment of the invention. System 100 may include a web server 114 for conducting an online transaction for purchasing goods and/or services, or otherwise making a payment. System 100 may include a computer 102 operable by a user for executing operations including, for example, purchasing goods and/or services using secure online transactions. System 100 may include a bank server 110 associated with an account (e.g., a user's bank account) for providing remote payment for goods and/or services using a transaction specific credit card number in exchange for the user's real secret data. System 100 may include a payment server 120 for providing payment or moving monies in connection with the transaction. Bank server 110, web server 114, and payment server 120 may communicate with computer 102 using connections, 126, 152, and 154, respectively. Typically connections 126, 152, and 154 are wireless connections, for example, over a network, such as, the Internet. However, other or alternate wired connections may be used. Typically components within computer 102 may communicate by wired, electrical, and/or physical connections. However, other or alternate wireless connections may be used.

Computer 102 may have a primary OS, such as main or primary OS 104, for performing typical machine-wide OS functionality, e.g., operating word-processing programs, providing a windowing environment, operating a program for providing an Internet webpage for conducting an online transaction, etc. OS 104 may, by providing an environment in which a, for example, web-browser, may operate, provide an Internet webpage for conducting an online transaction;

Computer 102 may include a secondary OS 140, such as an active management technology (AMT) OS, for providing an interface associated with (e.g., embedded within) the Internet webpage provided by the primary OS. In another embodiment, the Internet webpage and the interface may be provided by the same OS, for example, and may be appropriately encrypted for use by different structures of system 100.

The secondary OS 140 may provide a set of functions. The secondary OS 140 may for example operate hardware location 106 (e.g., a chip or chipset). Hardware location 106 may include a secure memory 108 (e.g., vault storage) for securely storing secret data and a processor including, for example, a manageability engine 112, for executing the secondary OS 140 for securely managing the secret data. The manageability engine 112 may store the secret data in a protected storage area, such as, the secure memory 108. Secure memory 108 may be integrity and confidentiality protected and typically cannot be accessed by the main OS 104. The secret data may remain safely in storage until a secure release of data is triggered for requesting a transaction specific code, such as, a one time use credit card number. Computer 102 may include a manageability engine kernel and/or thread 142 for managing processes, memory, devices, etc., of the manageability engine 112 and related components.

The primary or main OS 104 may provide another set of functions including providing connections to other devices over a network, such as, the Internet. The main OS 104 is typically the target of the misuse of data and thus may be considered non-secure.

Since hardware location 106 is operated by secondary OS 140 and not the main OS 104, the secret data stored in memory 108 of the hardware location 106 may be managed by the secondary OS 140 and not the main OS 104. Thus, the secret data may be safe from misuse typically directed at the main OS 104.

In other embodiments, the secret data is not used or stored in connection with a manageability engine or a secondary OS.

In conventional systems, a user may enter secret data into a user interface of a web-browser provided by a main OS of a computer. However, the main OS may not be secure and the secret data entered by the user may be misused. Thus, an alternate mechanism for entering secret data may be used.

Instead of entering secret data into a webpage provided by an Internet browser 130 of the main OS 104, according to embodiments of the invention, secret data may be entered into a secure embedded module 132, for example, provided by the manageability engine 112 using the secondary OS 140. The data entered into the embedded module 132 may be inaccessible to the main OS 104.

Computer 102 may include a display 118 (e.g., a monitor or screen) viewable by a user. The manageability engine 112 may provide an embedded module 132 displaying embedded graphics on a user interface (e.g. on display 118) prompting the user to enter secret data.

Computer 102 may include one or more input devices 116 (e.g., keyboard, mouse, etc.) operable by a user for example, for entering data. Input device 116 may include other or additional devices for a user to enter secret data to verify the user's identity, e.g., voice recognition audio receiver, credit card reader, eye or fingerprint scanner, etc.

Input device 116 and display 118 may be directly connected to a manageability engine 112 using secure and direct input/output connections 122 and 124, respectively.

Using secure connection 122, the embedded module 132 may securely accept data entered by a user via input device 116, for example, bypassing and hiding the secret data entered from the main OS 104.

The secondary OS 140 (e.g., or AMT OS) to verify the data entered by the user, for example, by comparing the entered data with the secret data stored in memory 108 of hardware location 106.

In one embodiment, when data entered into the embedded module 132 is accurate and/or verified, a controller 150 may trigger the transmission of a request to the bank server 110 providing the account. The request may include secret data stored in memory 108 to the bank server 110. Alternatively, the request does not include secret data, a credit card number, account number, etc. and may include other data such as a symbol, name, flag, Internet connection, encrypted data, etc. The request transmission may include releasing, writing, and/or transmitting the request (e.g., including secret data stored in memory 108) to the bank server 110. Hardware location 106 may include a credit card (CC) capabilities module 134 including a secure CC module 136 and a server communication module 138 for sending the request to the bank server 110 for requesting a transaction specific code. The request may be transmitted from the hardware location 106 over an Internet channel uniquely intended for the bank server 110 providing the account. For example, the request (e.g., or secret data) may be transmitted wirelessly over the Internet direct connection 126, for example, as an encrypted signal readable only by the bank server 110. For example, the request or secret data may be transmitted using an encrypted and/or direct connection 126. The hardware location 106 typically has one connection 126 for releasing the request or secret data stored in memory 108, for example, from CC capabilities module 134 to bank server 110. Thus, the bank server 110 may be the only device external to computer 102 that may access the secret data or the request therefore.

In response to transmitting the request (e.g., the secret data) and/or once the request is verified, the bank server 110 may send the transaction specific code (e.g., a one time use credit card number) for completing the online transaction. Servers other than a bank server (e.g., payment server 120 or another online payment server) may be used, and the information may be other than credit card information. For example, and transaction code allowing a user to engage in a financial transaction may be sent by a server.

The transaction specific code may be sent to the embedded module 132. A host embedded controller interface (HECI) 148 operated by the secondary OS 140 may access and transfer the code to an HECI driver 146 operated by the main OS 104. The HECI driver 146 may provide Internet browser 130 (e.g., displaying the transaction webpage) with the transaction specific code, which in turn may enter the code into, for example, a payment or credit card field of a webpage. The HECI driver 146 and the HECI interface 148 may connect the main OS 104 and the secondary OS 140. A communication relay module 144 and the HECI driver 146 may be used for the embedded module 132 to communicate with the secure CC module 136 and for the secure CC module 136 to communicate with the bank server 110. Thus, only the secure transaction specific code (e.g., a randomly generated one time use credit card number) may be revealed to the main OS 104, while the secret data is withheld therefrom.

Secret data is typically stored (e.g., in memory 108), entered (e.g., into input device 116) displayed (e.g., by display 118), and used (e.g., by manageability engine 112), by components of computer 102 which are operated by the secondary OS 140. Thus, the secret data is typically rendered unreadable to the main OS 104. Secure components or modules other than 112 and 140 may be used; in some embodiments such components or modules may be accessible by or part of OS 104.

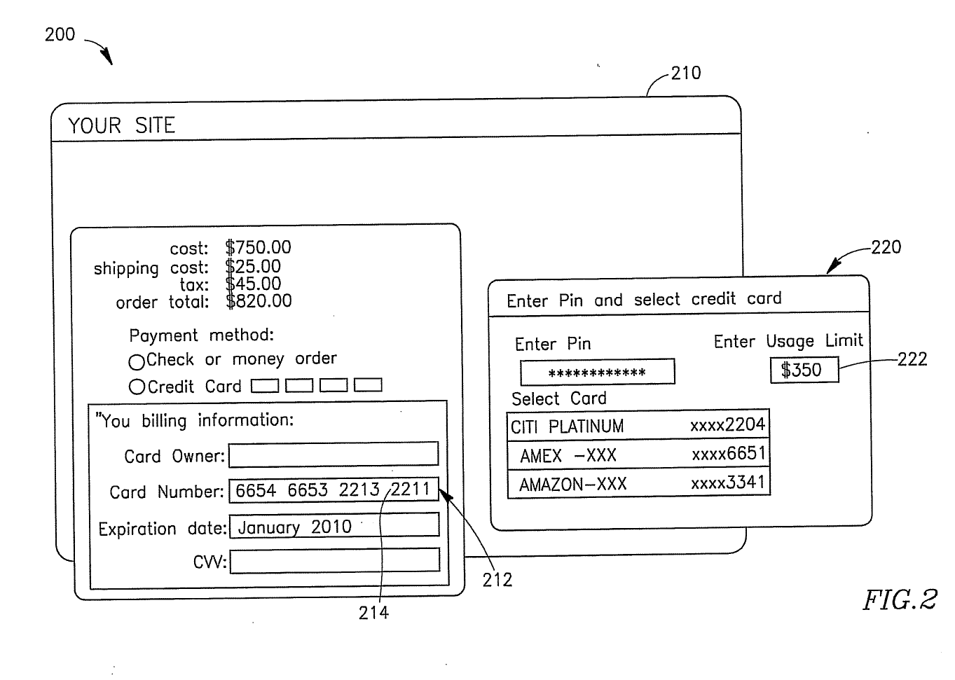

Reference is made to FIG. 2, which schematically shows a user display 200 including webpage 210 for providing transaction offer information and an embedded screen 220 for accepting user data according to an embodiment of the invention. The webpage 210 portion of the display 200 may be provided by Internet browser 130 operated by the main OS 104 and managed by the web server 114 (e.g., described in reference to FIG. 1). The main OS 104, web server 114, and data provided by or entered into the webpage are typically less secure than data handled by more secure components. Thus, the webpage 210 may provide typical information about the proposed transaction but does not provide, list, or request, any secret data.

Instead, secret data required for the transaction may be requested by and/or entered into embedded screen 220 provided by another component such as the manageability engine operated by the secondary OS 140. The embedded screen 220 may provide the user with a visualized display of fields 222 in which the user may enter secret data. Data entered into the embedded screen 220 may be directly sent to the embedded module 132 using secure connections 122 from the user input device 116. Since the input/output path 122 of user input device 116 is secure, the secret data entered into embedded screen 220, provided thereby, is likewise secure. The embedded screen 220 and the user data entered therein may be hidden from the main OS 104 and webpage 114.

In one embodiment, the data entered into embedded screen 220 may be used to trigger the secure release of secret data from secure memory 108 to the bank server for requesting a transaction specific credit card number. Thus, the secret data itself need not be entered by a user and may be safe from misuse.

In one embodiment, embedded screen 220 may be activated when a credit card number, transaction code or other secret data is requested on the webpage 210. The secure embedded module 132 may detect the payment request field provided by the webpage 210 or changes in or input thereto. When such a payment request field is detected, the HECI driver 146 (e.g., operated by the main OS 104) may signal the HECI interface 148 (e.g., operated by the secondary OS 140). In response, the embedded screen 220 (e.g., provided by the secondary OS 140) may be activated.

In one embodiment, the embedded screen 220 may prompt or request the user to enter secure data. The embedded screen 220 may include a message warning the user not to enter secret data into the webpage 210 and likewise, the embedded screen 220 may include a message indicating that it is safe for the user to enter secret data into embedded screen 220. The embedded screen 220 may block the user from entering secret data into the webpage 210 via an input device 116 override mechanism. For example, the user may not enter a sequence of numbers (e.g., interpreted by the override mechanism as a possible credit card or pin number) into a webpage field.

In one embodiment (shown in FIG. 2), the embedded screen 220 may appear on a user display 118, for example, as a pop-up page, for example, separate from webpage 210. Alternatively, the embedded screen 220 may appear as an integrated field in webpage 210, seamlessly replacing or positioned in front of, a credit card request field of the webpage 210.

When secret data is entered into the embedded screen 220 by a user, the manageability engine 112 or another secure component may retrieve the secret data stored in memory 108 to compare with and/or check the validity of the user entered data. If verified, the securely stored secret data from the vault memory of the hardware location may be securely sent to the bank server 110 or another server to request a transaction code such as a transaction specific credit card number for completing the proposed transaction listed on webpage 210.

Once the secret data is verified, bank server 110 may send manageability engine 112 for example a transaction specific credit card number corresponding to the proposed transaction. The manageability engine 112 (e.g., using HECI interface 148) may insert a transaction specific code 214 (e.g., a one time use credit card number) into data field 212 of webpage 210 (e.g., using HECI driver 146). Typically the transaction specific code 214 corresponds to the same account as a real or permanent credit card number, but may only be used for a predetermined transaction (e.g., to a second predetermined account, for a predetermined amount of money, for predetermined goods and/or services, etc.). Since the transaction specific code 214 itself is sufficiently secure (e.g., including randomly generated, one time use, data) the transaction specific code 214 may be entered into the non-secure webpage 210 data field 212 without a significant security risk.

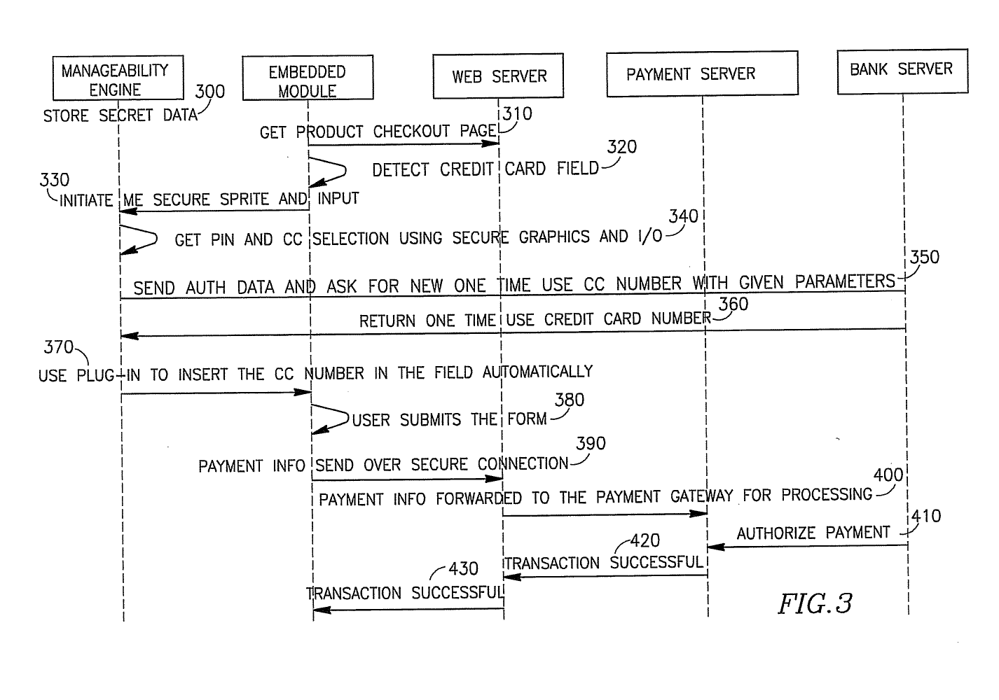

Reference is made to FIG. 3, which is a flowchart of a method according to an embodiment of the invention.

In operation 300, a manageability engine (e.g., manageability engine 112) may store secret data in a secure memory (e.g., memory 108) in a hardware location (e.g., secure hardware location 106) of a computer (e.g., computer 102). The secret data may include, for example, a password identification data (e.g., a social security number, answer to a predetermined personally generated question, etc.), a pin number (e.g., an automated teller machine (ATM) code) and/or a credit card number (e.g., or a portion thereof, such as the last four digits), or any other data used for accessing or controlling a bank account. The secret data may be stored in the hardware location on a user computer (e.g., a personal computer (PC)) such that typically the secret data may only be accessed by a designated bank server. The hardware location memory may have a unique output path to writing the secret data stored in this operation only to a server, for example a bank server (e.g., bank server 110) to which the secret data may be transferred. The bank server may have an account to which the secret data and/or credit card number corresponds.

In operation 310, a transaction may be initiated over for example a webpage (e.g., webpage 210). The webpage may be provided by a webpage server (e.g., webpage server 114) to the computer using an OS (e.g., OS 104) thereof. The webpage may be viewable to a user on a display (e.g., display 118).

The proposed transaction may be accepted by the user. For example, the user may select a “buy” or a “proceed to check-out”. This may trigger a signal to be sent from the computer to the webpage server to proceed with the transaction.

The webpage server (e.g., or a separate payment server) may request payment information from the user for completing the transaction. For example, the webpage may display one or more payment request fields in which the user may be prompted to enter secret data (e.g., a credit card number, expiration date, pin number, etc.) for activating payment from an account.

In operation 320, a module such as an embedded module (e.g., embedded module 220) may detect the payment request field.

In operation 330, the embedded module may activate a process or module such as a manageability engine for securely initiating a payment mechanism using a secure one time use transaction specific code (e.g., transaction specific code 214), such as, a randomly generated credit card number.

The embedded module may act as an intermediary between the webpage server requesting payment and the bank server providing payment. In order for the bank server to generate a transaction specific credit card number for payment, the bank server may require real secret data for verifying the user's identity, the user's account or credit card number, and/or intention to purchase.

In operation 340, a user may enter secret data (e.g., a pin number) into the embedded module using a secure input device such as a mouse or keyboard.

The user may enter a bank pin number, a credit card number, an identification number, a social security number, personalized data, the nature of the transaction, a description of the item for sale, a maximal spending limit, a solution to a security test, etc.

Since in one embodiment the embedded module is provided by the manageability engine using secure graphics and a secure input/output path, data entered into the embedded module may be securely and directly used by the manageability engine, for example, without communicating or being detected by the OS or other structures of the computer. The manageability engine may block the user from entering secret data into the payment request fields of the webpage.

The manageability engine may retrieve the secret data stored in operation 300 to compare with and/or check the validity of the data entered by the user in operation 340. If the manageability engine determines that the data entered by the user is valid, the process may proceed to operation 350. Otherwise, the process may end and, for example, a warning may be sent to the bank server that there has been an unauthorized request to access the corresponding bank account.

In operation 350, the manageability engine may securely send the bank server the secret data stored in operation 300, or an encrypted, coded, or otherwise derived version of the data. The secret data may be sent over a secure input/output path. The bank server may be the only recipient of the secret data (e.g., corresponding to the only output path for the data from the hardware location memory), ensuring that the data is not misused. The manageability engine may also send the bank server information regarding the transaction (e.g., the amount of money to be transferred, from and to which accounts to transfer the money, etc.). In return, the manageability engine may request a one time use transaction specific code such as a credit card number according to the transaction information.

In operation 360, the bank server may verify the secret data and send the computer a one time use transaction specific code such as a credit card number corresponding to the proposed transaction. The one time use transaction specific code may typically only be used for a single purchase (e.g., or limited number of purchases) and/or for specific transaction amount, goods and/or services, the movement of monies from one specific account to another, etc., and/or other requirements. The requirements may be set by the user and/or bank server and are typically monitored by the bank server. In other embodiments, the transaction code may be used in multiple transactions, or reused.

In operation 370, the manageability engine may use the embedded module to automatically enter the transaction specific code into the payment request field of the webpage. Alternatively, the transaction specific code may appear, for example, via the embedded module, and the user may select, drag, copy/paste, and/or enter the number manually. Since the transaction specific code is secure (e.g., a one time use, transaction specific, randomly generated credit card number) the number may be safely entered into the potentially non-secure payment request field of the webpage.

In operation 380, the user may submit the requested payment information to finalize the user-end portion of the transaction. For example, the user may click “submit” or “pay” or another authorization command.

In operation 390, the payment information entered into the payment request field of the webpage may be sent from the computer to the webpage server over a secure connection.

In operation 400, the payment information may be forwarded from the webpage server to a payment server (e.g., payment server 120) for processing the submitted payment information. In another embodiment, the payment information may be directly sent from the computer to the payment server and operation 390 may be omitted.

In operation 410, the payment server may authorize the submitted payment information to complete the transaction (e.g., including the transfer of monies, goods, and/or services, issuance of receipts, or other transaction processes).

In operation 420, the payment server may send a signal to the webpage server indicating that the transaction was successful and has been completed.

In operation 430, the webpage server may send a signal to the computer via the webpage indicating that the transaction was successful and has been completed. In another embodiment, the signal may be directly sent from the payment server to the computer and operation 420 may be omitted.

Other operations or sequences of operations may be used.

Embodiments of the invention may include an article such as a computer or processor readable medium, or a computer or processor storage medium, such as for example a memory, a disk drive, or a USB flash memory, encoding, including or storing instructions which when executed by one or more processors or controllers, carry out methods disclosed herein.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A computing device comprising:
a primary operating system to provide an Internet webpage for conducting an online transaction;
a secondary operating system to provide an interface associated with the Internet webpage, wherein data entered by a user into the interface is inaccessible to the primary operating system, and to verify the data entered by the user by comparing the entered data with secret data, wherein the secret data corresponds to an account, and wherein the secret data is stored in a hardware location of the computing device; and
a controller to, wherein when the data entered by the user is verified, trigger the transmission of a request to a server associated with the account, wherein in response to the transmitting, the computing device receives a transaction specific code for completing the online transaction.

2. The computing device of claim 1, wherein the secret data is transmitted from the hardware location over an Internet channel uniquely intended for the server associated with the account.

3. The computing device of claim 1, wherein the interface provided by the secondary operating system is embedded in the Internet webpage provided by the primary operating system.

4. The computing device of claim 1, comprising a manageability engine to operate said interface.

5. The computing device of claim 1, wherein the secondary operating system comprises an active management technology operating system.

6. The computing device of claim 1, comprising a host embedded controller interface connecting the primary and secondary operating systems.

7. The computing device of claim 1, wherein the transaction specific code is generated by the server associated with the account for transferring money from the account.

8. The computing device of claim 1, wherein the transaction specific code is a one-time use transaction specific code.

9. The computing device of claim 1, wherein the data entered by a user comprises a maximal spending limit for the online transaction.

10. A method comprising:
providing an Internet webpage using a primary operating system for conducting an online transaction;
providing an interface associated with the Internet webpage using a secondary operating system, wherein data entered by a user into the interface is inaccessible to the primary operating system;
verifying the data entered by the user using the secondary operating system by comparing the entered data with secret data, wherein the secret data corresponds to an account, and wherein the secret data is stored in a hardware location of a computing device;
when the data entered by the user is verified, transmitting a request to a server associated with the account; and
in response to the transmitting, receiving a transaction specific code for completing the online transaction.

11. The method of claim 10, wherein the secret data is transmitted from the hardware location over an Internet channel uniquely intended for the server associated with the account.

12. The method of claim 10, wherein the interface provided using the secondary operating system is embedded in the Internet webpage provided using the primary operating system.

13. The method of claim 10, wherein the transaction specific code is generated by the server associated with the account for transferring money from the account.

14. The method of claim 10, wherein the data entered by a user comprises an account pin number.

15. The method of claim 10, wherein the transaction specific code is a one-time use transaction specific code.

16. A computer-readable storage medium comprising a set of instructions that when executed by one or more processors in a computing apparatus cause the one or more processors to:
provide an Internet webpage using a primary operating system for conducting an online transaction;
provide an interface associated with the Internet webpage using a secondary operating system, wherein data entered by a user into the interface is inaccessible to the primary operating system;
verify the data entered by the user using the secondary operating system by comparing the entered data with secret data, wherein the secret data corresponds to an account, and wherein the secret data is stored in a hardware location of a computing device;
when the data entered by the user is verified, transmit a request to a server associated with the account; and
in response to the transmitting, receive a transaction specific code for completing the online transaction

17. The computer-readable storage medium of claim 16, wherein the secret data is transmitted from the hardware location over an Internet channel uniquely intended for the server associated with the account.

18. The computer-readable storage medium of claim 16, wherein the interface provided using the secondary operating system is embedded in the Internet webpage provided using the primary operating system.

19. The computer-readable storage medium of claim 16, wherein the transaction specific code is generated by the server associated with the account for transferring money from the account.

20. The computer-readable storage medium of claim 16, wherein the transaction specific code is a one-time use transaction specific code.
